(19) United States
(12) Patent Application Publication
(10) Pub. No.: US 2022/0129270 A1
(43) Pub. Date: Apr. 28, 2022

(54) METHOD AND SYSTEM FOR TOPK OPERATION

(71) Applicant: Marvell Asia Pte Ltd, Singapore (SG)

(72) Inventors: Avinash Sodani, San Jose, CA (US); Ulf Hanebutte, Gig Harbor, WA (US)

(21) Appl. No.: 17/507,247

(22) Filed: Oct. 21, 2021

Related U.S. Application Data
(60) Provisional application No. 63/105,140, filed on Oct. 23, 2020.

(51) Int. Cl. G06F 9/30; G06F 7/76; G06F 7/24; G06F 7/02; G06F 5/01

(52) U.S. Cl. CPC G06F 9/30036; G06F 7/76; G06F 5/01; G06F 7/02; G06F 7/24

(57) ABSTRACT

A method includes receiving a TopK instruction to sort a highest K elements of a vector data. A first K elements of the vector data are sorted and stored in a first register. Another element of the vector data is read and determined whether it has a value that is greater than or is within a range of values of the first K elements. A position of the another element within the first K elements is determined if the another element has a value within that is within the range of values. A subset of the elements of the first K elements that are smaller than the another element are shifted down after determining the position of the another element in the first K elements. The another element is inserted in the determined position after the shifting. The process is repeated for each remaining element of the vector data.

### CROSS-REFERENCE TO RELATED APPLICATIONS

This application claims the benefit and priority to the U.S. Provisional Patent Application No. 63/105,140, filed Oct. 23, 2020, which is incorporated herein in its entirety by reference.

### BACKGROUND

Electronic devices have become an integral part of daily life. Many electronic applications utilize ranking of results using TopK operation. For example, in one particular application in machine learning (ML), a TopK is used to identify the top K indices or entries with the highest probabilities among a large set of data entries, e.g., classifying an image among thousands of classes. Similarly, TopK operation has become a common operator in other applications such as ad-hoc search and retrieval in relational databases, document and multimedia databases, etc.

In general, to perform TopK, elements in a vector are compared to one another in order to identify the largest K values in sorted order and the index locations associated with each of those largest K values are also tracked at the same time. The amount of data being processed has increased substantially in recent years given an increase in ML applications as well as increased amount of data being exchanged. While comparing elements of a vector to identify the largest K values in sorted order may be feasible for small vectors, it has become computationally expensive for larger vector lengths (especially given the increase in the amount of data) because large amount of computation power is wasted on sorting elements of the vector that are not even in the top K elements. Other conventional methods sequentially identify the maximum value within a given vector and repeat that for the next maximum value until the top K values are sorted. Unfortunately, sequentially identifying the maximum values to obtain the top K values in a sorted fashion requires repeating certain instructions multiple times, e.g., reading the vector elements multiple times, performing comparison instructions multiple times, etc., which results in computation inefficiencies.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 depicts an example of a diagram of a hardware-based system configured to perform a TopK operation according to one aspect of the present embodiments.

FIGS. 2A-2D depict an example of a diagram of a hardware-based system configured to perform various sub-operations for a TopK operation according to one aspect of the present embodiments.

FIG. 3 depicts an example of a flow diagram for performing a TopK operation according to one aspect of the present embodiments.

### DETAILED DESCRIPTION

The following disclosure provides many different embodiments, or examples, for implementing different features of the subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Before various embodiments are described in greater detail, it should be understood that the embodiments are not limiting, as elements in such embodiments may vary. It should likewise be understood that a particular embodiment described and/or illustrated herein has elements which may be readily separated from the particular embodiment and optionally combined with any of several other embodiments or substituted for elements in any of several other embodiments described herein. It should also be understood that the terminology used herein is for the purpose of describing the certain concepts, and the terminology is not intended to be limiting. Unless defined otherwise, all technical and scientific terms used herein have the same meaning as commonly understood in the art to which the embodiments pertain.

As discussed, TopK operation has become prevalent for ranking results in various applications such as ML applications. Unfortunately, TopK operation has traditionally been implemented in an inefficient and wasteful manner, e.g., unnecessary use of memory, excessive processing power, etc. Accordingly, a need has arisen to reduce the amount of computing resources, e.g., memory, processing power, etc., used in performing a TopK operation. Moreover, a need has arisen to perform a TopK operation as fast as possible. Some embodiments, as presented herein, leverage the arithmetic logic units (ALUs) and registers (e.g., register depths) within a ML hardware to perform the TopK operation in an efficient manner. It is appreciated that in some embodiments, for a small K (that depends on the relative size of the register and ALUs), a single path through the vector may be sufficient while for a large K, the vector is read once from the memory where the original vector is stored while intermediate stages of the data processing are stored in on-chip memories and where multiple reads/writes may occur.

In general, a TopK operation identifies the top K index locations of a vector having the largest data. For illustrative purposes, a vector data may be V=[100, 2, 101, 53, 33, 53, 67, 94] and it may have eight elements. A TopK operation for K=4 identifies the indices (in this illustrative example, the index starts with 0 but in other embodiments, the index may start with 1) of the largest four values. In other words, index 2 corresponding to element 101, index 0 corresponding to element 100, index 7 corresponding to element 94, and index 6 corresponding to element 67. As such, the TopK operation with K=4 results in [2, 0, 7, 6]. It is appreciated that if two elements of the vector data have the same value (e.g., index 3 and 5 for element 53) then the index of the first occurrence of the element (i.e. index 3) is taken, followed by a later element (i.e. index 5).

The proposed approach leverages and utilizes the architecture of a ML hardware-based system in some embodiments that are implemented with an instruction set architecture (ISA) to utilize the processing element registers in an efficient manner to limit the amount of data movement. According to some embodiments, a register width is used to track the top K values when performing a TopK operation. For illustrative purposes, the width of register is presumed to be 8 and that K is also 8. However, it is appreciated that the register width may be any width and that the value of K may be any value. As such, the register width of 8 and K of 8 is used for illustrative purposes and should not be construed as limiting the scope of the embodiments. The vector data may have any number of elements, e.g., 1000 elements, 1024 elements, 256 elements, etc. It is appreciated that in general the value of K is less than or equal to the width of the register.

In some embodiments, the first K elements of the vector data are read, sorted, and stored in the register. When a new element of the vector data is read, if the newly read element does not have a value within the range of the first K elements, or greater, that are sorted and stored in the register, then the next element is read and the process is repeated. However, if the newly read element has a value within the range of the first K elements that are sorted and stored in the register, then elements within the register that are smaller than the read element are moved and shifted to make room for the new element that was read. The elements within the register that are greater than or equal to the read element are also moved and the newly read element is inserted in the vacant position. As such, the register is updated with new top K elements. It is appreciated that the process is repeated until every element of the vector data is processed and final top K elements are obtained. It is appreciated that the index associated with each element of the vector data may be tracked throughout process.

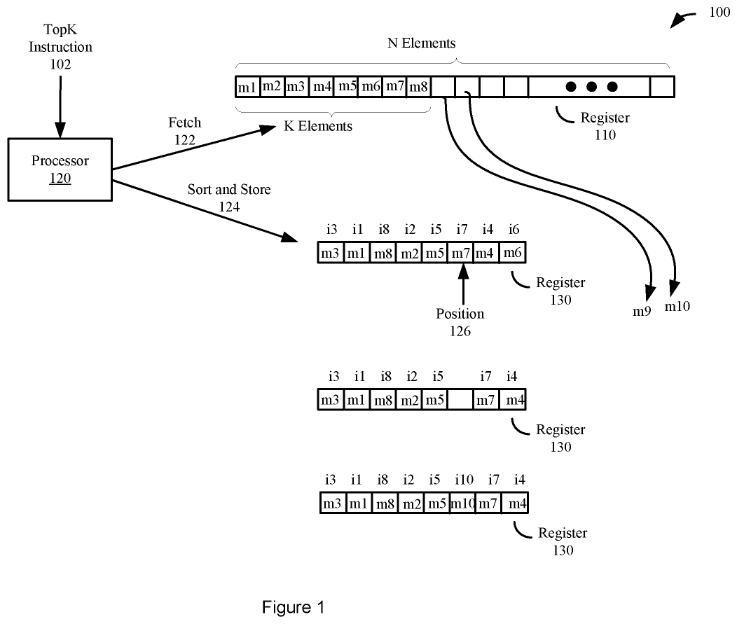

FIG. 1 depicts an example of a diagram of a hardware-based system 100 configured to perform a TopK operation according to one aspect of the present embodiments. Although the diagrams depict components as functionally separate, such depiction is merely for illustrative purposes. It will be apparent that the components portrayed in this figure can be arbitrarily combined or divided into separate software, firmware and/or hardware components. Furthermore, it will also be apparent that such components, regardless of how they are combined or divided, can execute on the same host or multiple hosts, and wherein the multiple hosts can be coupled by one or more networks. When the software instructions are executed, the one or more hardware components become a special purposed hardware component for performing the TopK operation.

In the example of FIG. 1, the data vector includes N elements and is stored in register 110. In one nonlimiting example, a TopK instruction 102 is received by a processor 120. The processor 120 fetches 122 the first K elements from the register 110. It is appreciated that the first K elements may be sequential (as shown) or they may be fetched based on certain patterns, e.g., strides. In this nonlimiting example, K is 8 and m1, m2, . . . , m8 corresponding to the first K elements of register 110 are read and sorted by the processor 120. The processor 120 communicates the sorted first K elements 124 to be stored in register 130. It is appreciated that register 130 may have a width greater than K, e.g., 8, 9, 10, . . . , 16, etc. In this nonlimiting example, m3 has the highest value followed by m1, m8, m2, m5, m7, m4, and m6 respectively. As such, m3, m1, m8, m2, m5, m7, m4, and m6 are stored in register 130. It is appreciated that the index associated with each element may also be tracked. In other words, index i3 corresponding to m3 is tracked as well as other elements. The index may be tracked in a register, as an example.

It is appreciated that the next element of the vector data may be read, i.e. m9. Once read, the processor 120 may determine whether the new element, i.e. m9, has a value that is within a range of values already stored in the register 130 or higher, i.e. whether m9 has a value higher than or between the highest value element m3 and the lowest value element m6. For illustrative purposes, it is determined that m9 has a value that is less than m6. Accordingly, no further processing is performed for element m9 of the vector data.

It is appreciated that the next element, i.e. m10, from the vector data stored in the register 110 is read by the processor 120. Similar to element m9, the processor 120 determines whether the newly read element m10 has a value that is greater than or within the range of values corresponding to elements stored in register 130, i.e. in this example between the highest value element m3 and lowest value element m6.

In one nonlimiting example, m10 is determined to be greater than element m7 but less than element m5. As such, the processor 120 identifies the position 126 where m10 is to be inserted. The smallest value element, i.e., m6 in this example, will be shifted out as it will no longer be in the top K elements. In some embodiments a subset of elements, e.g., m7, m4, and m6, are shifted. Thus, m6 is eliminated from register 130 while the position of m7 and m4 is changed. Accordingly, a vacant position is created to insert the element value m10. Once m10 is inserted, its index i10 may also be tracked. As such, register 130 contains the updated top K (in this example top 8) elements of the first 10 elements of the vector data read from register 110. The process is repeated for each remaining element of the vector data that is stored in the register 110 until all elements are read and the top K elements are updated. Once all elements are read and processed, as described above, the register 130 will contain the top K elements of the vector data.

As illustrated by the example above, the number of data movements and data read is reduced in comparison to the conventional method. For example, the elements of vector data stored in the register 110 are read once. The intermediate values are stored in other registers and updated, as needed, to form an updated top K elements, thereby reducing the amount of resource usage, e.g., processing power, memory usage, data movement, etc.

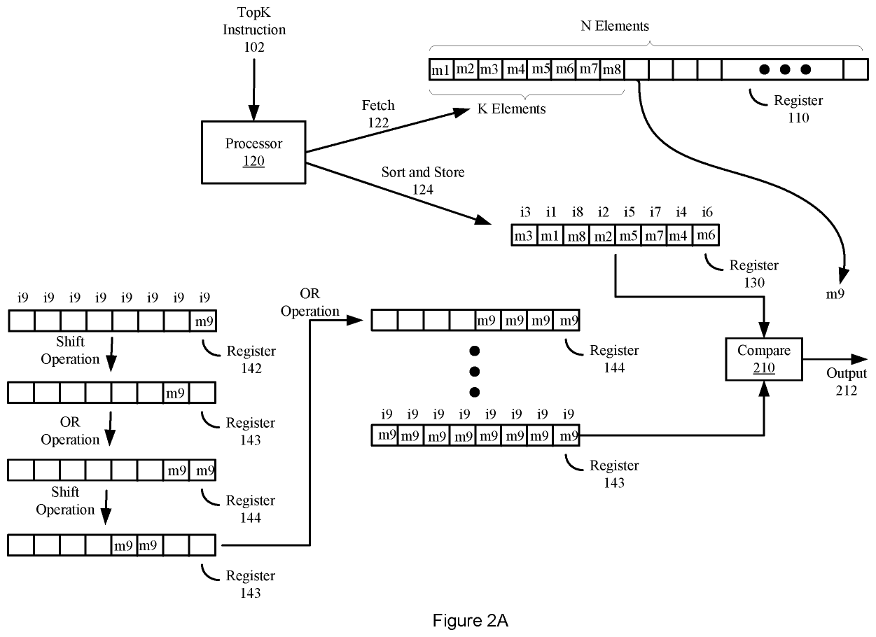

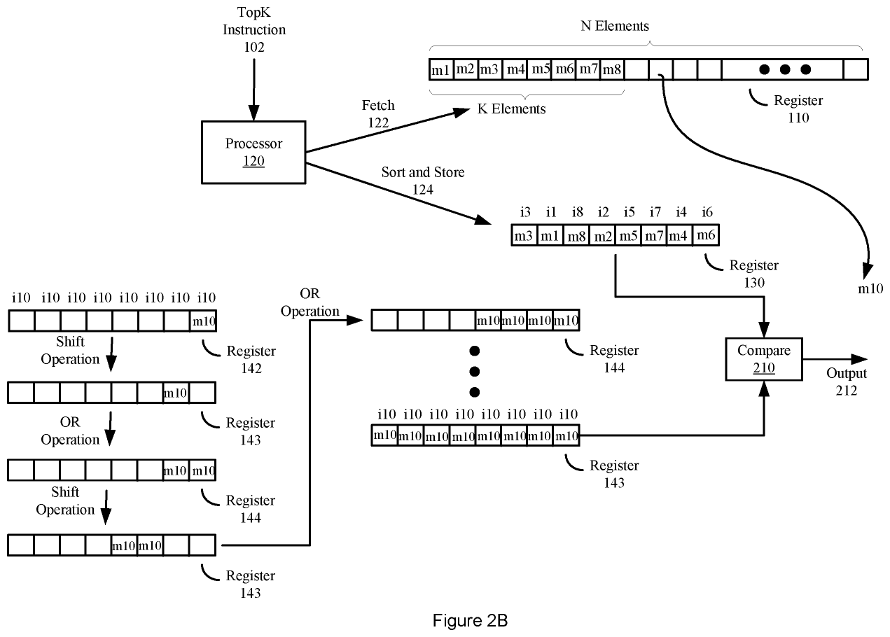

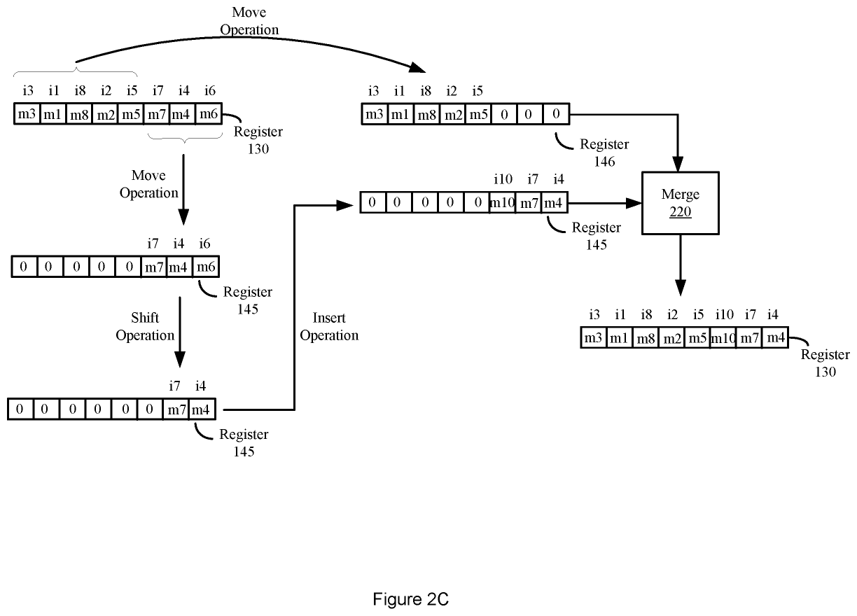

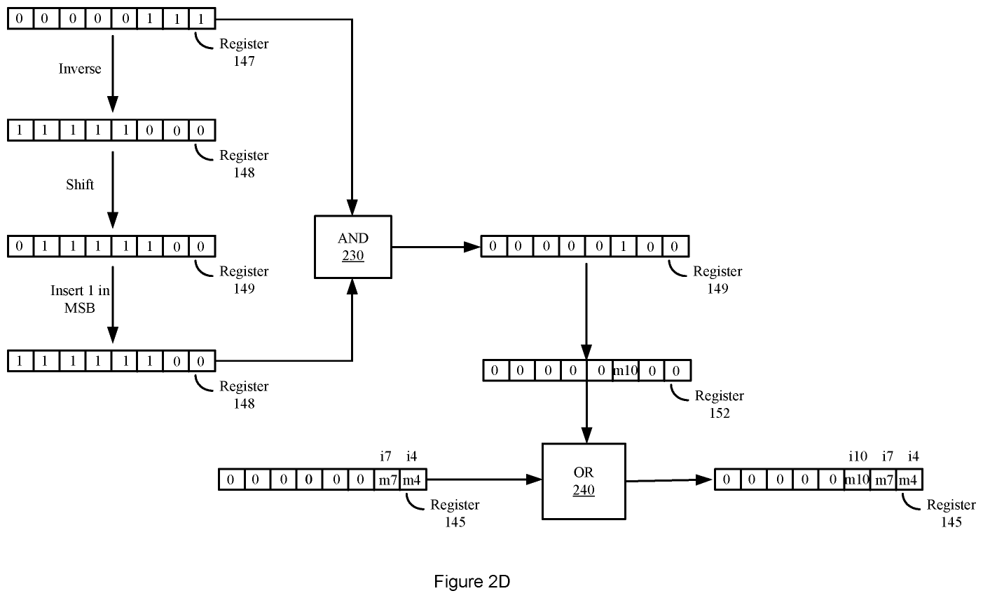

FIGS. 2A-2D depict an example of a diagram of a hardware-based system configured to perform various sub-operations for a TopK operation according to one aspect of the present embodiments. Referring specifically to FIG. 2A, a similar process to FIG. 1 is illustrated. In this embodiment, one implementation to determine whether the next element read from the vector data stored in the register 110 is greater than or within the range of values for the elements stored in the register 130 is illustrated but should not be construed as limiting the scope of the embodiments. In this nonlimiting example, the next element m9 is read from the vector data stored in the register 110. The element m9 is stored in the register 142 and its index is tracked, e.g., in a different register. In some embodiments, the element m9 is broadcast to each element of the register. For example, m9 in the register 142 may be shifted and stored in the register 143. The registers 142 and 143 may be logically ORed together and the result may be stored in the register 144. It is appreciated that the process is repeated until each element of the register contain the element m9. For example, the elements of the register 144 are shifted and stored in the register 143. The registers 143 and 144 are logically ORed together and the result may be stored in the register 144. The process is repeated until m9 is broadcasted to each element of the register 143. In other words, the register 143 contains m9 for each of its K elements. The processor 120 may contain a compare block 210 that compares the elements of the register 143 to that of the register 130. The comparison outputs 212 the result of the comparison. In this example, it is determined that m9 is smaller than the smallest element of the register 130, hence m6. As such, no further processing is performed on m9.

Referring now to FIG. 2B, the next element (i.e. m10) of the vector data from the register 110 is read and the process similar to FIG. 2A may be performed. For illustration purposes and as discussed in FIG. 1, it is presumed that m10 has a value in between elements m3 and m6. As such, when the content of the register 143 is compared with that of the register 130, a determination is made that m10 is to be inserted in the register 130. In some embodiments, the position where the element m10 is to be inserted in the register 130 may be determine when the comparison reveals two comparison where one element from a first register is greater than another element from a second register and that is followed by the subsequent element of the first register being smaller than the subsequent element of the second register. In this example, m3>m10, m1>m10, m8>m10, m2>m10, m5>m10 but m7<m10. As such, the position where m10 is to be inserted is determined as the vacant position, which opens after m7 and subsequent elements are shifted to the right.

Referring now to FIG. 2C, after it is determined that an element is to be inserted in the top K elements, a subset of the elements (in this example m3, m1, m8, m2, and m5) from the register 130 is moved to the register 146 and another subset of the elements (in this example m7, m4, and m6) from the register 130 is moved to the register 145. It is appreciated that the subset to be moved is determined based on the location at which the new element (m10 in this example) is to be inserted. In this illustrative example, a subset of the elements that are smaller than m10 are moved to the register 145 while the elements that are greater than or equal to m10 are moved to the register 146. It is appreciated that the indices of the elements may be tracked (e.g., using a different register). Once the subset m7, m4, and m6 are moved to the register 145 the higher order positions are filled with zeros. The content of the register 145 is shifted down, and as such m6 is dropped out while the position of elements m7 and m4 is changed (having one lower order bit). Once the shift occurs, the element m10 that is greater than m7 can be inserted in a position where m7 used to be (i.e. 3^{rd} lowest order element). The lower order positions for the register 146 that correspond to the elements that are smaller than m10 are filled with zeros.

In some embodiments, the registers 146 and 145 contain higher order subset elements and the lower order subset elements respectively. As such, if merged, the result will contain the updated top K elements. The processor 120 may perform a merge 220 operation between the registers 146 and 145 and store the result in the register 130. In some embodiments, the merge operation may be a logical OR operation between the two registers. As such, the register 130 now contains updated top K elements. The process is repeated for each remaining element of the vector data stored in the register 110 until all elements are processed accordingly and the top K elements are updated in the register 130.

Referring now to FIG. 2D, another implementation to identify the position to insert m10 is illustrated. In this example, a register 147 is used where elements corresponding to elements that are smaller than m10 are filled with ones and other elements are filled with zeros. The values of the register 147 are inverted in the register 148. The elements of the register 147 are shifted by one and stored in the register 149, as an example. Subsequently, a value of 1 is inserted in the most significant bit position of the register 149 and the result is stored in the register 148. It is appreciated that in some embodiments, the result may be stored in the register 149 instead. According to one implementational embodiment, the registers 147 and 148 are logically ANDed at 230 together and the result [0, 0, 0, 0, 0, 1, 0, 0] is stored in the register 149. The position corresponding to value 1 is where m10 element is to be inserted. As such, m10 is inserted in the register 152 into a position as identified by the register 149 where other elements are 0. The registers 152 and 145 are ORed at 240 together in order to insert the m10 element in the appropriate position followed by the next two smaller elements, m7 and m4. It is appreciated that the result may be stored in the register 145 that is subsequently used in the merge operation with the register 146 to update the top K values of the register 130. It is appreciated that the index associated with each element may also be tracked.

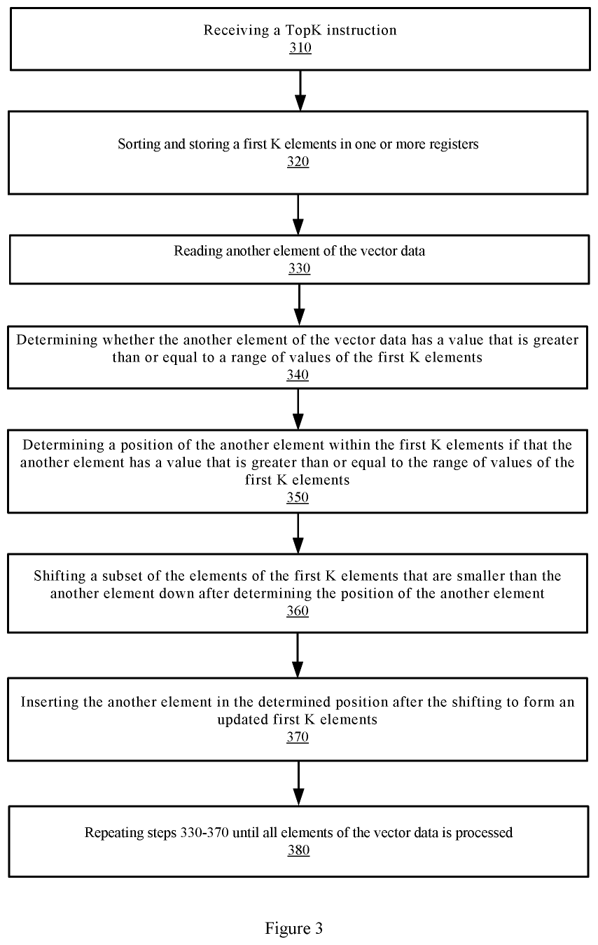

FIG. 3 depicts an example of a flow diagram for performing a TopK operation according to one aspect of the present embodiments. It is appreciated that in some embodiments, the value and/or the index of the vector element may be tracked. It is further appreciated that the process steps, as described below, may be performed in any order (e.g., in parallel processing and pipelining instructions) and that the particular ordering as presented herein is for illustrative purposes and should not be construed as limiting the scope of the embodiments. At step 310, a TopK instruction is received, as described in FIGS. 1 and 2A-2B. The TopK instruction may be associated with a vector data with n elements, as described above in FIGS. 1-2D. At step 320, the first K elements of the vector data are sorted and stored in one or more registers, as discussed in FIGS. 1-2D. At step 330, another element of the vector data is read, as described above. At step 340, it is determined whether the another element has a value greater than the value of the first K elements or has a value within the range of values of first K elements, as described above in FIGS. 1-2B. In other words, it is determined whether the another element has a value that is smaller than the smallest value of the first K element or not. At step 350, if it is determined that the another element has a value that is greater than the smallest value of the first K elements, then the position of the another element with respect to the first K elements is determined, as described in FIGS. 1 and 2C-2D. In other words, it is determined where to insert the another element. At step 360, a subset of the elements from the first K elements that are smaller than the another element are shifted down by one in order to create a vacant position for the another element, as described in FIGS. 1 and 2C-2D. At step 370, the another element is inserted into the determined position, as described in FIGS. 1 and 2C-2D, after the subset of elements are shifted down in order to form an updated first K elements. It is appreciated that at step 380, steps 330-370 are repeated for each remaining element of the vector data in order to form a top K elements for the vector data, as described in FIGS. 1-2D.

The foregoing description of various embodiments of the claimed subject matter has been provided for the purposes of illustration and description. It is not intended to be exhaustive or to limit the claimed subject matter to the precise forms disclosed. Many modifications and variations will be apparent to the practitioner skilled in the art. Embodiments were chosen and described in order to best describe the principles of the invention and its practical application, thereby enabling others skilled in the relevant art to understand the claimed subject matter, the various embodiments and the various modifications that are suited to the particular use contemplated.

What is claimed is:

1. A computer-implemented method comprising:
a) receiving a TopK instruction to sort a highest K elements of a vector data having n number of elements;
b) retrieving, sorting, and storing a first K elements of the vector data in a first register;
c) reading another element of the vector data;
d) determining whether the another element of the vector data has a value that is greater than or equal to a range of values of the first K elements;
e) determining a position of the another element within the first K elements if the another element has a value that is greater than or equal to the range of values in the first register;
f) shifting a subset of the elements of the first K elements that are smaller than the another element down after determining the position of the another element in the first K elements;
g) inserting the another element in the determined position in a vacant position after the shifting to form an updated first K elements; and
h) repeating steps (c), (d), (e), (f) and (g) for each remaining element of the vector data until each element of the vector data is processed.

2. The method of claim 1, wherein (d) comprises:
broadcasting the another element of the vector data to each position within a second register having a same size as the first register; and
comparing the another element within the second register to elements within the first register.

3. The method of claim 1, wherein subsequent to (e) and prior to (f) the method further comprises:
moving the subset of the elements from the first register to a third register having a same size as the first register, and wherein a zero value is stored in remaining positions of the third register, and wherein the shifting of (f) is performed for the third register.

4. The method of claim 3 further comprising shifting elements within the third register having a nonzero value.

5. The method of claim 1, wherein subsequent to (e) the method further comprises moving elements other than the subset of elements to a fourth register that has a same size as the first register, and wherein a zero value is stored in remaining positions of the fourth register.

6. The method of claim 1 further comprising:
moving the subset of the elements from the first register to a third register having a same size as the first register, and wherein a zero value is stored in remaining positions of the third register;
shifting the elements within the third register with nonzero values by one;
moving elements other than the subset of elements to a fourth register that has a same size as the first register, and wherein a zero value is stored in remaining positions of the fourth register; and
performing a logical OR operation between the third register and the fourth register to form an updated first K elements.

7. The method of claim 6 further comprising storing the updated first K elements in the first register.

8. The method of claim 1 further comprising tracking index position associated with the vector data.

9. The method of claim 1, wherein (e) comprises:
asserting a bit value, in a fifth register, corresponding to a position of each element of the subset of the elements, wherein the fifth register has a same size as the first register;
de-asserting a bit value, in the fifth register, corresponding to a position of elements other than the subset of elements;
asserting a bit value, in a sixth register, corresponding to a position of elements other than the subset of elements, wherein the sixth register has a same size as the first register;
shifting elements within the sixth register;
inserting an asserted bit value in a most significant bit position, in the sixth register; and
performing a logical AND operation between the fifth and the sixth register, wherein an asserted value bit identifies the position of the another element in step (e).

10. The method of claim 1, wherein (d) comprises comparing a value of the another element to a smallest value of the first K elements.

11. A hardware-based system, comprising:
a processor configured to receive executable instructions, wherein the processor is further configured to receive a TopK instruction, and wherein the processor is configured to read a first K element of a vector data with n number of elements in response to the TopK instruction; and
one or more registers configured to store data to perform the TopK instruction, and wherein a first K elements of the vector data is sorted and stored in the one or more registers,
and wherein for each element of the vector data the processor is configured to:
a) determine whether the each element of the vector data has a value that is greater than or equal to a range of values of the first K elements;
b) determine a position of the each element within the first K elements if the each element has a value that is greater than or equal to the range of values of the first K elements;
c) shift a subset of the elements of the first K elements that are smaller than the each element down after determining the position of the each element;
d) insert the each element in the determined position after the shifting to form an updated first K elements; and
e) repeat steps (a), (b), (c), and (d) for each remaining element of the vector data until each element of the vector data is processed.

12. The hardware-based system of claim 11, wherein the each element is broadcast to each position of one register from the one or more registers and wherein the one register is compared to another register of the one or more registers that stores the first K elements, wherein the one register has a same size as the another register, and wherein the comparison determines whether the each element of the vector data has a value that is greater than or equal to a range of values of the first K elements.

13. The hardware-based system of claim 11, wherein after (b) and prior to (c) the processor is configured to:
move the subset of the elements from one register of the one or more registers that stores the first K elements to a second register of the one or more registers having a same size as the first register, and wherein a zero value is stored in remaining positions of the second register, and wherein (c) is performed for the second register.

14. The hardware-based system of claim 13 wherein the processor is further configured to shift elements within the second register having a nonzero value.

15. The hardware-based system of claim 11, wherein subsequent to (b) the processor is configured to move elements other than the subset of elements to a third register of the one or more registers that has a same size as a first register storing the first K elements, and wherein a zero value is stored in remaining positions of the third register.

16. The hardware-based system of claim 11, wherein the processor is further configured to:
move the subset of the elements from a first register of the one or more registers to a third register having a same size as the first register, and wherein a zero value is stored in remaining positions of the third register;
shift the elements within the third register with nonzero values by one;
move elements other than the subset of elements to a fourth register that has a same size as the first register, and wherein a zero value is stored in remaining positions of the fourth register; and
perform a logical OR operation between the third register and the fourth register to form an updated first K elements.

17. The hardware-based system of claim 16, wherein the processor is further configured to store the updated first K elements in the first register.

18. The hardware-based system of claim 11, wherein the processor is further configured to track index position associated with the vector data.

19. The hardware-based system of claim 11, wherein to determine the position the processor is configured to:
assert a bit value, in a fifth register, corresponding to a position of each element of the subset of the elements, wherein the fifth register has a same size as a first register that stores the first K elements;
de-assert a bit value, in the fifth register, corresponding to a position of elements other than the subset of elements;
assert a bit value, in a sixth register, corresponding to a position of elements other than the subset of elements, wherein the sixth register has a same size as the first register;
shift elements within the sixth register;
insert an asserted bit value in a most significant bit position, in the sixth register; and
perform a logical AND operation between the fifth and the sixth register, wherein an asserted bit value identifies the position of the each element in (b).

20. The hardware-based system of claim 11, wherein to perform (a) the processor is configured to compare a value of the each element to a smallest value of the first K elements.

21. A hardware-based system, comprising:
a) a means for receiving a TopK instruction to sort a highest K elements of a vector data with n number of elements;
b) a means for sorting and storing a first K elements of the vector data in a first register;
c) a means for reading another element of the vector data;
d) a means for determining whether the another element of the vector data has a value that is greater than or equal to a range of values of the first K elements;
e) a means for determining a position of the another element within the first K elements if the another element has a value within that is greater than or equal to the range of values in the first register;
f) a means for shifting a subset of the elements of the first K elements that are smaller than the another element down after determining the position of the another element in the first K elements;
g) a means for inserting the another element in the determined position in a vacant position after the shifting to form an updated first K elements; and
h) a means for repeating steps (c), (d), (e), (f) and (g) for each remaining element of the vector data until each element of the vector data is processed.

22. A computer-implemented method comprising:
a) receiving a TopK instruction to sort a highest K elements of a vector data having n number of elements;
b) retrieving, sorting, and storing a first N elements of the vector data in a first register, wherein N is smaller than or equal to K;
c) reading another element of the vector data;
d) determining whether the another element of the vector data has a value that is greater than or equal to a range of values of the first N elements;
e) determining a position of the another element within the first N elements if the another element has a value that is greater than or equal to the range of values in the first register;
f) shifting a subset of the elements of the first N elements that are smaller than the another element down after determining the position of the another element in the first N elements;
g) inserting the another element in the determined position in a vacant position after the shifting to form an updated first N elements; and
h) repeating steps (c), (d), (e), (f) and (g) for each remaining element of the vector data until each element of the vector data is processed.
